(19) United States
(12) Patent Application Publication
(10) Pub. No.: US 2021/0171767 A1
(43) Pub. Date: Jun. 10, 2021

(54) THERMOPLASTIC COMPOSITIONS HAVING GOOD STABILITY

(71) Applicant: Covestro Deutschland AG, Leverkusen (DE)

(72) Inventors: Andreas Seidel, Dormagen (DE); Helmut Werner Heuer, Siegen (DE); Rolf Wehrmann, Krefeld (DE)

(21) Appl. No.: 16/771,722

(22) PCT Filed: Dec. 17, 2018
(86) PCT No.: PCT/EP2018/085128

§ 371 Date: Jun. 11, 2020

(30) Foreign Application Priority Data
Dec. 19, 2017 (EP) 17208343.8

(51) Int. Cl. C08L 69/00

(52) U.S. Cl. CPC C08L 69/005

(57) ABSTRACT

The invention relates to a composition for production of a thermoplastic moulding compound, wherein the composition comprises or consists of at least the following constituents:
A) 30% to 94% by weight of a polymer or polymer mixture consisting of at least one representative selected from aromatic polycarbonate and aromatic polyestercarbonate and optionally additionally comprising aromatic polyester,
B) 5% to 65% by weight of rubber-based graft polymer B.1, optionally in a mixture with rubber-free vinyl (co)polymer B.2,
C) 0.001% to 1% by weight of at least one ester of a sulfonic acid,
D) 0% to 30% by weight of one or more polymer additives,
and to a process for producing the moulding compound, to the moulding compound itself, to the use of the composition or of the moulding compound for production of moulded articles and to the moulded articles themselves.

The present invention relates to thermoplastic impact-modified polycarbonate and/or polyestercarbonate moulding compounds and to the compositions thereof, to a process for producing the moulding compounds, to the use of the moulding compounds for production of moulded articles and to the moulded articles themselves.

Thermoplastic polycarbonate and polyestercarbonate compositions have been known for a long time, and these materials are used to produce moulded articles for a wide variety of applications, for example in the automobile sector, for rail vehicles, for the construction sector, in the electrical/electronics sector and in domestic appliances. For improvement of the rheological and mechanical properties, further thermoplastics are frequently added as blend partners. In many cases, particularly to improve toughness at low temperatures, graft polymers are used as impact modifiers.

The production of moulded articles from the moulding compounds with such compositions is generally effected at elevated temperatures and leads to thermal stress on the moulding compounds. This can result in unwanted degradation reactions that adversely affect the processing characteristics of the moulding compounds and the properties of the moulded articles. Therefore, thermal stabilizers that are intended to suppress these degradation reactions are frequently added in the production of the moulding compounds.

EP 1 609 818 A2 discloses polycarbonate compositions comprising esters of sulfur-containing organic acids that have improved stability of the polycarbonate to thermal stress.

EP 1 612 231 A1 discloses a process for preparing polycarbonate, wherein esters of organic sulfur-containing acids are added between the medium- and high-viscosity reactor, and the use of these esters for inhibition of catalytically active impurities in the preparation of polycarbonate by the melt transesterification method.

However, these documents do not disclose impact-modified compositions comprising graft polymer. In the case of mixtures of polycarbonate and polyestercarbonate with other thermoplastics, however, sensitivity to thermal stress can increase further and necessitate special stabilization. Further influencing factors can likewise be important for the attainment of the desired properties.

WO 2013/160371 A1 discloses PC/ABS compositions, especially those based on ABS prepared by the emulsion polymerization method, wherein the compositions feature a low content of free bisphenol A.

WO 2013/160373 A1 discloses PC/ABS compositions comprising polycarbonate with a low OH end group content (preferably prepared by the interfacial polymerization process) and ABS with a low alkali content (preferably prepared by the bulk polymerization process) that feature high thermal processing stability in relation to gloss, polycarbonate degradation and content of free bisphenol A, and have improved stress-cracking resistance.

WO 2007/065579 A1 discloses polycarbonate compositions comprising graft polymer that are stabilized by addition of a Brønsted acid.

However, the addition of additives, particularly acids, as thermal stabilizers harbours the risk that the thermal stability is improved, but other properties are simultaneously affected. For instance, stability under moist, warm conditions (i.e. stability to hydrolytic polymer degradation) is frequently reduced by the use of thermal stabilizers as additives.

It was thus desirable to provide impact-modified polycarbonate or polyestercarbonate compositions, optionally further comprising polyester, and moulding compounds produced therefrom that feature the combination of good stability to thermal stress and good hydrolysis stability.

It has now been found that, surprisingly, the advantageous properties are possessed by a composition for producing a thermoplastic moulding compound, wherein the composition comprises at least the following constituents:
A) 30% to 94% by weight, preferably 40% to 80% by weight, more preferably 50% to 75% by weight, of a polymer or polymer mixture consisting of at least one representative selected from aromatic polycarbonate and aromatic polyestercarbonate and optionally additionally comprising aromatic polyester,
B) 5% to 65% by weight, preferably 10% to 50% by weight, more preferably 20% to 45% by weight, of rubber-based graft polymer B.1, optionally in a mixture with rubber-free vinyl (co)polymer B.2,
C) 0.001% to 1% by weight, preferably 0.002% to 0.2% by weight, more preferably 0.005% to 0.05% by weight, of at least one sulfonic ester, preferably an ester of an aromatic sulfonic acid, more preferably an ester of a sulfonic acid of one of the formulae (XI) to (XVI) shown below, most preferably the sulfonic ester of the formula (XVII) shown below,
D) 0% to 30% by weight, preferably 0.1% to 10% by weight, more preferably 0.2% to 5% by weight, of one or more polymer additives.

When component B comprises both B.1 and B.2, the stated proportion of component B is the sum total of the proportions of B.1 and B.2.

In a preferred embodiment, the composition consists to an extent of at least 90% by weight, more preferably to an extent of at least 95% by weight, especially preferably at least 98% by weight, of components A to D. In a further-preferred embodiment, the composition consists solely of components A to D.

In a preferred embodiment, the thermoplastic moulding compound is a moulding compound comprising aromatic polycarbonate, more preferably aromatic polycarbonate comprising bisphenol A-derived structural elements, especially preferably aromatic polycarbonate based exclusively on bisphenol A as diphenol.

A further problem addressed was that of providing a process by which an impact-modified polycarbonate and polyestercarbonate composition can be produced and in which the moulding compound obtained has good thermal stability.

It was especially desirable to provide a process by which a composition comprising, as component A, polycarbonates and/or polyestercarbonates containing Fries structures of the formulae IV to VII shown below can be processed to a thermally stable moulding compound, especially also when the composition contains lithium (introduced, for example, as a process-related impurity in graft polymer B). Moulding compounds produced from such compositions often have advantageous rheological and mechanical properties and are based on ingredients of good commercial availability. However, the thermal stability of such moulding compounds in particular is inadequate for some applications, and so there was a particular need for an improved production process.

It has now been found that the desired improvements are achieved by a process for producing an impact-modified thermoplastic moulding compound comprising
A) 30% to 94% by weight, preferably 40% to 80% by weight, more preferably 50% to 75% by weight, of a polymer or polymer mixture consisting of at least one representative selected from aromatic polycarbonate and aromatic polyestercarbonate and optionally additionally comprising aromatic polyester,
B) 5% to 65% by weight, preferably 10% to 50% by weight, more preferably 20% to 45% by weight, of rubber-based graft polymer B.1, optionally in a mixture with rubber-free vinyl (co)polymer B.2,
D) 0% to 30% by weight, preferably 0.1% to 10% by weight, more preferably 0.2% to 5% by weight, of one or more polymer additives,
   wherein the components are mixed with one another at a temperature of 200 to 350° C. and melted and interdispersed in a compounding unit,
   characterized in that, in the process, component C) added to the composition is an ester of a sulfonic acid in a concentration of 0.001% to 1% by weight and
   characterized in that either components A, B, C and D and any further components of the composition are mixed in a single step or else, alternatively, component C is first premixed in a first step with the entirety or a portion of component A at room temperature or at an elevated temperature of preferably 200 to 350° C.

When component B comprises both B.1 and B.2, the stated proportion of component B is the sum total of the proportions of B.1 and B.2.

### Component A

Component A consists of at least one representative selected from the group consisting of aromatic polycarbonate and aromatic polyestercarbonate and optionally additionally aromatic polyester.

Component A preferably comprises aromatic polycarbonate.

It is particularly preferable when one or more aromatic polycarbonates are employed as component A.

Aromatic polycarbonates and/or aromatic polyestercarbonates in accordance with component A which are suitable in accordance with the invention are known from the literature or preparable by processes known from the literature (for preparation of aromatic polycarbonates see, for example, Schnell, “Chemistry and Physics of Polycarbonates”, Interscience Publishers, 1964, and also DE-B 1 495 626, DE-A 2 232 877, DE-A 2 703 376, DE-A 2 714 544, DE-A 3 000 610, DE-A 3 832 396; for preparation of aromatic polyestercarbonates, for example DE-A 3 077 934).

Aromatic polycarbonates are produced for example by reaction of diphenols with carbonyl halides, preferably phosgene and/or with aromatic diacarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Preparation via a melt polymerization process by reaction of diphenols with diphenyl carbonate, for example, is likewise possible.

Diphenols for preparation of the aromatic polycarbonates and/or aromatic polyestercarbonates are preferably those of the formula (I)

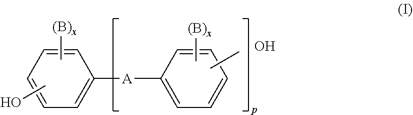

where
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused,
   or a radical of formula (II) or (III)

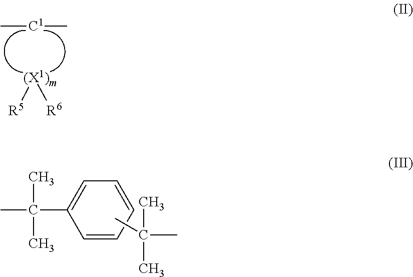

B is in each case C₁ to C₁₂-alkyl, preferably methyl, halogen, preferably chlorine and/or bromine,
x is independently at each occurrence 0, 1 or 2,
p is 1 or 0, and
R⁵ and R⁶ can be chosen individually for each X¹, and are each independently hydrogen or C₁ to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dhydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Further preferred diphenols are those of the general formula (Ia), (Ib) and (Ic):

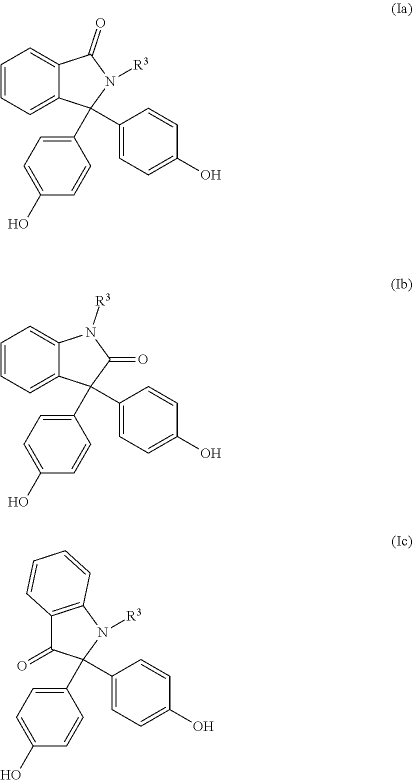

in which R³ is C₁-C₄-alkyl, aralkyl or aryl, preferably methyl or phenyl, most preferably phenyl.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by processes known from the literature.

Examples of chain terminators suitable for the preparation of the thermoplastic aromatic polycarbonates include phenol, p-chlorophenol, p-tert-butylphenol or 2,4,6-tribromophenol, but also long-chain alkylphenols such as 4-[2-(2,4,4-trimethylpentyl)]phenol, 4-(1,3-tetramethylbutyl)phenol according to DE-A 2 842 005 or monoalkylphenol or dialkylphenols having a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol %, based on the molar sum of the diphenols used in each case.

The thermoplastic aromatic polycarbonates may be branched in a known manner, and preferably through incorporation of 0.05 to 2.0 mol %, based on the sum of the diphenols used, of trifunctional or more than trifunctional compounds, for example those having three or more phenolic groups.

Both homopolycarbonates and copolycarbonates are suitable. For preparation of inventive copolycarbonates in accordance with component A, it is also possible to use 1 to 25% by weight, preferably 2.5 to 25% by weight, based on the total amount of diphenols to be used, of polydiorganosiloxanes having hydroxyaryloxy end groups. These are known (U.S. Pat. No. 3,419,634) and can be produced by processes known from the literature. The preparation of polydiorganosiloxane-containing copolycarbonates is described in DE-A 3 334 782.

Preferred polycarbonates are, as well as the bisphenol A homopolycarbonates, the copolycarbonates of bisphenol A with up to 15 mol %, based on the molar sums of diphenols, of other diphenols specified as preferred or particularly preferred, especially 2,2-bis(3,5-dibromo-4-hydroxyphenyl)propane.

Aromatic dicarbonyl dihalides for preparation of aromatic polyestercarbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacyl dichlorides of isophthalic acid and of terephthalic acid in a ratio of from 1:20 to 20:1.

In the preparation of polyestercarbonates, a carbonyl halide, preferably phosgene, is also additionally used as a bifunctional acid derivative.

Useful chain terminators for the preparation of the aromatic polyestercarbonates include, apart from the monophenols already mentioned, the chlorocarbonic esters thereof and the acid chlorides of aromatic monocarboxylic acids, which may optionally be substituted by C₁ to C₂₂-alkyl groups or by halogen atoms, and aliphatic C₂ to C₂₂-monocarbonyl chlorides.

The amount of chain terminators in each case is 0.1 to 10 mol %, based on moles of diphenol in the case of the phenolic chain terminators and on moles of dicarbonyl dichloride in the case of monocarbonyl chloride chain terminators.

The aromatic polyestercarbonates may also incorporate aromatic hydroxycarboxylic acids.

The aromatic polyestercarbonates may be either linear or branched in a known manner (see DE-A 2 940 024 and DE-A 3 007 934).

Branching agents used may, for example, be tri- or multifunctional carbonyl chlorides, such as trimesyl trichloride, cyanuric trichloride, 3,3′,4,4′-benzophenonetetracarbonyl tetrachloride, 1,4,5,8-naphthalenetetracarbonyl tetrachloride or pyromellitic tetrachloride, in amounts of 0.01 to 1.0 mol % (based on dicarbonyl dichlorides used), or tri- or multifunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol,tetra(4-hydroxyphenyl)methane,2,6-bis(2-hydroxy-5-methylbenzyl)-4-methylphenol, 2-(4-hydroxyphenyl)-2-(2,4-dihydroxyphenyl)propane, tetra(4-[4-hydroxy-phenylisopropyl]phenoxy)methane, 1,4-bis[4,4′-dihydroxytriphenyl)methyl]benzene, in amounts of 0.01 to 1.0 mol %, based on diphenols used. Phenolic branching agents may be initially charged together with the diphenols; acid chloride branching agents may be introduced together with the acid dichlorides.

The proportion of carbonate structural units in the thermoplastic aromatic polyestercarbonates may be varied as desired. Preferably, the proportion of carbonate groups is up to 100 mol %, especially up to 80 mol %, more preferably up to 50 mol %, based on the sum total of ester groups and carbonate groups. Both the ester component and the carbonate component of the aromatic polyestercarbonates may take the form of blocks or be in random distribution in the polycondensate.

In a preferred embodiment, the aromatic polycarbonates or polyestercarbonates suitable as component A have a weight-average molecular weight M_{w} (determined by gel permeation chromatography (GPC) in methylene chloride with polycarbonate as standard) of 15 000 g/mol to 50 000 g/mol, preferably of 22 000 g/mol to 35 000 g/mol, in particular of 24 000 to 32 000 g/mol.

In a particular embodiment, the polycarbonates or polyestercarbonates used as component A contain one or more structures of the general formulae (IV) to (VII) that are the consequence of Fries rearrangement reactions and are referred to hereinafter as “Fries structures” or “rearrangement structures”:

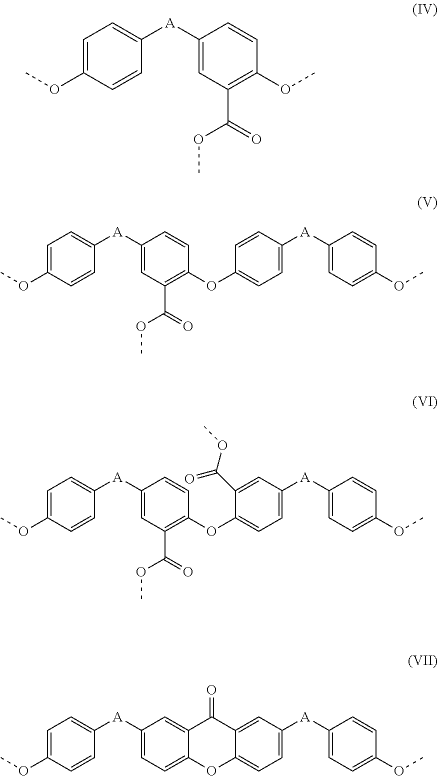

in which the phenyl rings may independently be mono- or disubstituted by C1-C8-alkyl, halogen such as chlorine or bromine, preferably C1-C4-alkyl, particularly methyl, and A is as defined in formula (I),
where, in this particular embodiment, the amount of the structural units (IV) to (VII) adds up to at least 50 mg/kg, based on the sum total of aromatic polycarbonate and polyestercarbonate of component A. Preferably, the amount of the structural units (IV) to (VII) is 50 to 10 000 mg/kg, more preferably 1000 to 3000 mg/kg, most preferably 200-1200 mg/kg, based in each case on the sum total of aromatic polycarbonate and polyestercarbonate of component A.

The structural units of the formulae (IV) to (VII) are derived from and result from the diphenols used for the preparation of the polycarbonate. For example, in the case of bisphenol A as diphenol, the phenyl rings of the rearrangement structures are unsubstituted.

In the case of degradation by alkaline hydrolysis of the aromatic polycarbonates and/or aromatic polyestercarbonates of component A for analytical purposes, the low molecular weight degradation products of the formulae (IVa) to (VIIa) that are characteristic of the respective rearrangement structures, shown by way of example for bisphenol A as diphenol (i.e. for A=isopropylidene), are formed and the amounts thereof, after separation by means of HPLC, are determined by nuclear magnetic resonance spectroscopy (¹H NMR).

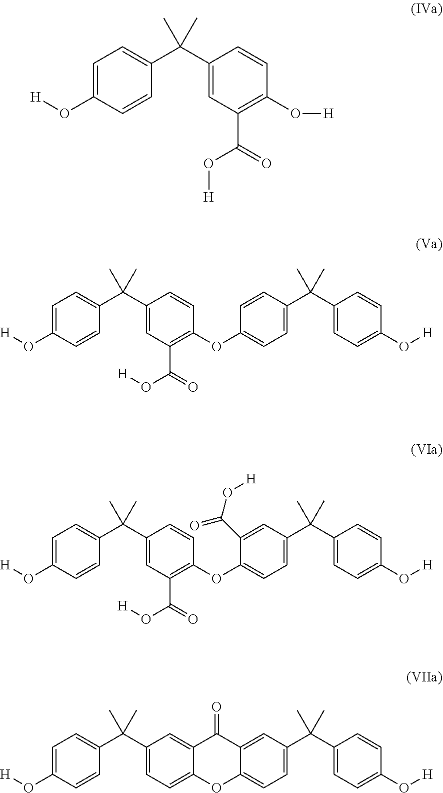 [SMILES: CC(C)(c1ccc(O)cc1)c1ccc(O)c(C(=O)O)c1 ; CC(C)(c1ccc(O)cc1)c1ccc(Oc2ccc(C(C)(C)c3ccc(O)cc3)cc2C(=O)O)cc1 ; CC(C)(c1ccc(O)cc1)c1ccc(Oc2ccc(C(C)(C)c3ccc(O)cc3)cc2C(=O)O)c(C(=O)O)c1 ; CC(C)(c1ccc(O)cc1)c1ccc2oc3ccc(C(C)(C)c4ccc(O)cc4)cc3c(=O)c2c1]

Such aromatic polycarbonates and/or polyestercarbonates containing Fries structures are prepared in a particular embodiment by the melt polymerization process.

In a further embodiment, the aromatic polycarbonates and/or polyestercarbonates used as component A have a content of phenolic OH end groups preferably of at least 100 mg/kg, more preferably of at least 200 mg/kg, further preferably of at least 300 mg/kg, especially of at least 400 mg/kg.

The concentration of phenolic OH end groups in component A is determined by means of infrared spectroscopy according to Horbach, A.; Veiel, U.; Wunderlich, H., Makromolekulare Chemie, 1965, volume 88, p. 215-231.

In a further embodiment, the aromatic polycarbonates and/or polyestercarbonates being used as component A have a content of phenolic OH end groups preferably of at least 100 mg/kg, more preferably of at least 200 mg/kg, further preferably of at least 300 mg/kg, especially of at least 400 mg/kg, and contain one or more Fries structures of the general formulae (IV) to (VII).

In a further embodiment, the aromatic polycarbonates and/or polyestercarbonates being used as component A have a content of phenolic OH end groups preferably of at least 100 mg/kg, more preferably of at least 200 mg/kg, further preferably of at least 300 mg/kg, especially of at least 400 mg/kg, contain one or more Fries structures of the general formulae (IV) to (VII), and have been prepared by the melt polymerization method.

In a further embodiment, component A comprises, in addition to the polycarbonate and/or polyestercarbonate, one or more aromatic polyesters as well.

In a preferred embodiment, useful aromatic polyesters are polyalkylene terephthalates.

In a particularly preferred embodiment, these are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

The preferred aromatic polyalkylene terephthalates may contain, as well as terephthalic acid radicals, up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain not only ethylene glycol and/or butane-1,4-diol radicals but also up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-p-hydroxyethoxyphenyl)propane and 2,2-bis(4-hydroxypropoxyphenyl)propane (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to aromatic polyalkylene terephthalates which have been prepared solely from terephthalic acid and the reactive derivatives thereof (e.g. the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The preferably used aromatic polyalkylene terephthalates have a viscosity number of 0.4 to 1.5 dl/g, preferably 0.5 to 1.2 dl/g, measured in phenol/o-dichlorobenzene (1:1 parts by weight) in a concentration of 0.05 g/ml according to ISO 307 at 25° C. in an Ubbelohde viscometer.

The aromatic polyalkylene terephthalates can be prepared by known methods (see, for example, Kunststoff-Handbuch [Plastics Handbook], volume VIII, p. 695 et seq., Carl-Hanser-Verlag, Munich 1973).

In a preferred embodiment, component A comprises an aromatic polycarbonate, more preferably based on bisphenol A. In a further-preferred embodiment, component A is free of polyesters, and in a particularly preferred embodiment free of polyesters and polyestercarbonates.

In a further preferred embodiment, component A is an aromatic polycarbonate, more preferably an aromatic polycarbonate comprising bisphenol A-derived structural units, especially an aromatic polycarbonate based exclusively on bisphenol A as diphenol.

### Component B

Component B is a rubber-based graft polymer B.1 or alternatively a mixture of such a rubber-based graft polymer B.1 with rubber-free vinyl (co)polymers B.2.

The graft polymers B.1 used in accordance with the invention in component B comprise

B.1.1 5% to 95% by weight, preferably 20% to 92% by weight, especially 30% to 91% by weight, based on the graft polymer, of at least one vinyl monomer on
B.1.2 95% to 5% by weight, preferably 80% to 8% by weight, especially 70% to 9% by weight, based on the graft polymer, of one or more rubber-elastic graft bases having glass transition temperatures <10° C., further preferably <0° C., especially preferably <−20° C.,
where the polymer chains formed from the monomers B.1.1 are chemically bonded to the graft base B.1.2 or are enclosed in the rubber particles such that they do not escape from the rubber particles in the course of production and processing of the compositions according to the invention.

Unless expressly stated otherwise in the present invention the glass transition temperature is determined for all components by differential scanning calorimetry (DSC) according to DIN EN 61006 (1994 version) at a heating rate of 10 K/min with determination of Tg as the midpoint temperature (tangent method).

The graft base B.1.2 generally has a median particle size (D50) of 0.05 to 10.00 μm, preferably 0.1 to 5.0 μm, more preferably 0.2 to 1.5 μm.

The median particle size D50 is the diameter with 50% by weight of the particles above it and 50% by weight below it. Unless expressly stated otherwise in the present invention it is determined for all components by means of ultracentrifuge measurement (W. Scholtan, H. Lange, Kolloid-Z. und Z. Polymere 250 (1972), 782-1796).

The monomers B.1.1 are preferably mixtures of
B.1.1.1 50% to 99% by weight, more preferably 65% to 85% by weight, further preferably 70% to 80% by weight, based in each case on the sum total of B.1.1.1 and B.1.1.2, of vinylaromatics and/or ring-substituted vinylaromatics (such as styrene, α-methylstyrene, p-methylstyrene, p-chlorostyrene) and/or (C1-C8)-alkyl (meth)acrylates, such as methyl methacrylate, ethyl methacrylate, and
B.1.1.2 1% to 50% by weight, especially preferably 15% to 35% by weight, further preferably 20% to 30% by weight, based in each case on the sum total of B.1.1.1 and B.1.1.2, of vinyl cyanides (unsaturated nitriles such as acrylonitrile and methacrylonitrile) and/or (C1-C8)-alkyl (meth)acrylates, such as methyl methacrylate, n-butyl acrylate, t-butyl acrylate, and/or derivatives (such as anhydrides and imides) of unsaturated carboxylic acids, for example maleic anhydride.

Preferred monomers B.1.1.1 are selected from at least one of the monomers styrene, α-methylstyrene and methyl methacrylate; preferred monomers B.1.1.2 are selected from at least one of the monomers acrylonitrile, maleic anhydride and methyl methacrylate. Particularly preferred monomers are B.1.1.1 styrene and B.1.1.2 acrylonitrile. Alternatively preferred monomers are B.1.1.1 methyl methacrylate and B.1.1.2 methyl methacrylate.

Suitable graft bases B.1.2 for the graft polymers include, for example, diene rubbers, EP(D)M rubbers, i.e. those based on ethylene/propylene and optionally diene, acrylate, polyurethane, silicone, chloroprene, ethylene/vinyl acetate, and acrylate-silicone composite rubbers.

Preferred graft bases B.1.2 are diene rubbers, preferably comprising butadiene or copolymers of dienes, preferably comprising butadiene, and further copolymerizable vinyl monomers (e.g. according to B.1.1.1 and B.1.1.2) or mixtures of one or more of the aforementioned components.

A particularly preferred graft base B.1.2 is pure polybutadiene rubber. In a further preferred embodiment B.1.2 is styrene-butadiene rubber, particularly preferably styrene-butadiene block copolymer rubber.

The gel content of the graft base B.1.2 is at least 30% by weight, preferably at least 40% by weight, especially at least 60% by weight, based in each case on B.1.2 and measured as the insoluble fraction in toluene.

The gel content of the graft base B.1.2 is determined at 25° C. in a suitable solvent as the fraction insoluble in these solvents (M. Hoffmann, H. Krömer, R. Kuhn, Polymeranalytik I und II [Polymer Analysis I and II], Georg Thieme-Verlag, Stuttgart 1977).

Suitable polymers of component B are, for example, ABS polymers or MBS polymers, as described, for example, in DE-A 2 035 390 (=U.S. Pat. No. 3,644,574) or in DE-A 2 248 242 (=GB-A 1 409 275), or in Ullmanns Enzyklopädie der Technischen Chemie [Ullmann's Encyclopedia of Industrial Chemistry], vol. 19 (1980), p. 280 ff.

The graft copolymers in component B are produced by free-radical polymerization, for example by emulsion, suspension, solution or bulk polymerization. Component B.1 may also be mixtures of graft polymers prepared by different methods.

Suitable graft polymers B.1 also include ABS polymers produced by redox initiation with an initiator system of organic hydroperoxide and ascorbic acid according to U.S. Pat. No. 4,937,285.

In grafting, as is well known, the graft monomers B.1.1 are not necessarily grafted completely onto the graft base. Products of grafting reactions thus often still contain significant proportions of free copolymer (i.e. copolymer not chemically bonded to the graft base) having a composition analogous to that of the graft shell. In the context of the present invention, component B.1 is understood to mean exclusively the graft polymer as defined above, while the copolymer not chemically bonded to the graft base and not enclosed in the rubber particles which is present for production-related reasons is assigned to component B.2.

The proportion of this free copolymer in the products of grafting reactions can be determined from the gel contents thereof (proportion of free copolymer=100% by weight−gel content of the product in % by weight), by determining the gel content at 25° C. in a suitable solvent (such as for instance acetone) as the content insoluble in these solvents.

When the graft polymers B.1 are prepared in emulsion polymerization, they contain

B.1.1 5% to 75% by weight, preferably 20% to 60% by weight, more preferably 25% to 50% by weight, based on the graft polymer, of at least one vinyl monomer on
B.1.2 95% to 25% by weight, preferably 80% to 40% by weight, more preferably 75% to 50% by weight, based on the graft polymer, of one or more rubber-elastic graft bases having glass transition temperatures <10° C., further preferably <0° C., especially preferably <−20° C.

In the case of use of graft polymers B.1 prepared in emulsion polymerization, component B usually contains lithium in a concentration of <1 mg/kg; B is often free of lithium.

In the case of use of graft polymers B.1 prepared in emulsion polymerization, component B usually contains a content of other alkali metals that adds up to >10 mg/kg, often >20 mg/kg.

The content of alkali metals is ascertained by inductively coupled plasma optical emission spectroscopy (ICP-OES) with an internal standard. For this purpose, the sample is digested in concentrated nitric acid in a microwave at 200° C. and 200 bar, diluted to 1 M nitric acid and analysed.

The graft bases B.1.2 of graft polymers B.1 prepared in emulsion polymerization have a median particle size (D50) of 0.05 to 2.00 μm, preferably of 0.1 to 1.0 μm, more preferably of 0.2 to 0.5 μm.

When the graft polymers B.1 are prepared in suspension, solution or bulk polymerization, they contain

B.1.1 80% to 95% by weight, preferably 84% to 92% by weight, more preferably 87% to 91% by weight, based on the graft polymer, of at least one vinyl monomer on
B.1.2 20% to 5% by weight, preferably 16% to 8% by weight, more preferably 13% to 9% by weight, based on the graft polymer, of one or more rubber-elastic graft bases having glass transition temperatures <10° C., further preferably <0° C., especially preferably <−20° C.

In the case of use of graft polymers B.1 prepared in bulk polymerization, component B usually contains lithium in a concentration of >1 mg/kg, often in a concentration of >2 mg/kg.

In the case of use of graft polymers B.1 prepared in bulk polymerization, component B usually contains a content of other alkali metals that adds up to <10 mg/kg, often <5 mg/kg.

The graft bases B.1.2 of graft polymers B.1 prepared in suspension, solution or bulk polymerization have a median particle size (D50) of 0.3 to 10.00 μm, preferably of 0.4 to 5.0 μm, more preferably of 0.5 to 1.5 μm.

Further particularly suitable graft polymers prepared by the emulsion polymerization method are MBS modifiers with the core-shell structure and modifiers with a core-shell structure containing a core of a silicone, acrylate or silicone-acrylate composite rubber and a shell of either styrene and acrylonitrile or alternatively of methyl methacrylate.

Component B.2 comprises (co)polymers of at least one monomer from the group of the vinylaromatics, vinyl cyanides (unsaturated nitriles), (C1 to C8)-alkyl (meth)acrylates, unsaturated carboxylic acids and derivatives (such as anhydrides and imides) of unsaturated carboxylic acids.

Especially suitable as component B.2 are (co)polymers of

B.2.1 50% to 99% by weight, preferably 65% to 85% by weight, more preferably 70% to 80% by weight, based on the (co)polymer C, of at least one monomer selected from the group of the vinylaromatics (for example styrene, α-methylstyrene), ring-substituted vinylaromatics (for example p-methylstyrene, p-chlorostyrene) and (C1-C8)-alkyl (meth)acrylates (for example methyl methacrylate, n-butyl acrylate, tert-butyl acrylate) and
B.2.2 1% to 50% by weight, preferably 15% to 35% by weight, more preferably 20% to 30% by weight, based on the (co)polymer C, of at least one monomer selected from the group of vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate), unsaturated carboxylic acids and derivatives of unsaturated carboxylic acids (for example maleic anhydride and N-phenylmaleimide).

These (co)polymers B.2 are resinous, thermoplastic and rubber-free.

Particular preference is given to the copolymer of B.2.1 styrene and B.2.2 acrylonitrile.

In a further preferred embodiment, B.2 is a polymer a B.2.1 and B.2.2 methyl methacrylate.

This rubber-free vinyl (co)polymer B.2 has a weight-average molecular weight M_{W} of 30 to 250 kg/mol, preferably of 70 to 200 kg/mol, especially of 90 to 180 kg/mol.

In the context of the present invention, the weight-average molecular weight M_{w} of the rubber-free vinyl (co)polymer B.2 in component B is measured by gel permeation chromatography (GPC) in tetrahydrofuran against a polystyrene standard.

### Component C

Component C is a sulfonic ester or a mixture of different sulfonic esters.

In a preferred embodiment, the sulfonic esters used in component C are esters of aromatic sulfonic acids R—SO₂(OH) where R is a C₆- to C₂₀-aryl or C₇- to C₁₂-aralkyl, preferably selected from the list consisting of phenyl, cresyl, xylenyl, propylphenyl, butylphenyl, tert-butylphenyl, more preferably selected from the list consisting of phenyl, cresyl, xylenyl, most preferably phenyl.

Examples of esters suitable as component C are selected from at least one compound of
a) the formula (VIII)

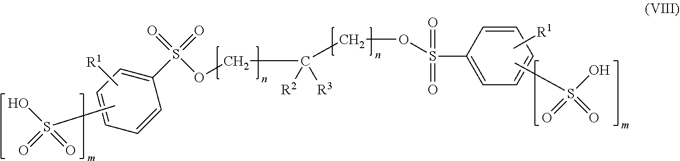

b) the formula (IX)

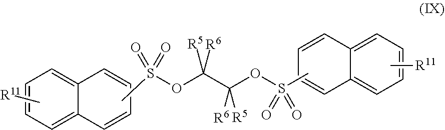

c) the formula (X)

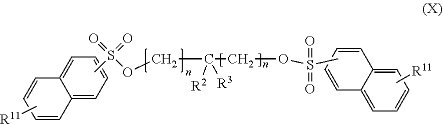

where, in the formulae (VIII), (IX) and (X),
R¹ is independently hydrogen or unsubstituted or halogen-substituted C₁-C₂₀-alkyl,
R² and R³ are independently hydrogen, C₁-C₆-alkyl or C₄-C₃₀-alkylcarboxyl, or are the radical

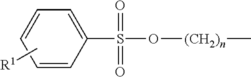

in which
R¹ is as defined above,
m is independently 0 or 1,
n is 0, 1 or 2,
R⁵ and R⁶ are independently hydrogen or C₁-C₂₀-alkyl, where alkyl may be substituted by halogen,
R¹¹ is independently hydrogen or di-(C₁-C₄)-alkylamino.

Further examples of sulfonic esters that are suitable as component C and are preferably used as such are compounds of the formulae (XI) to (XVI)

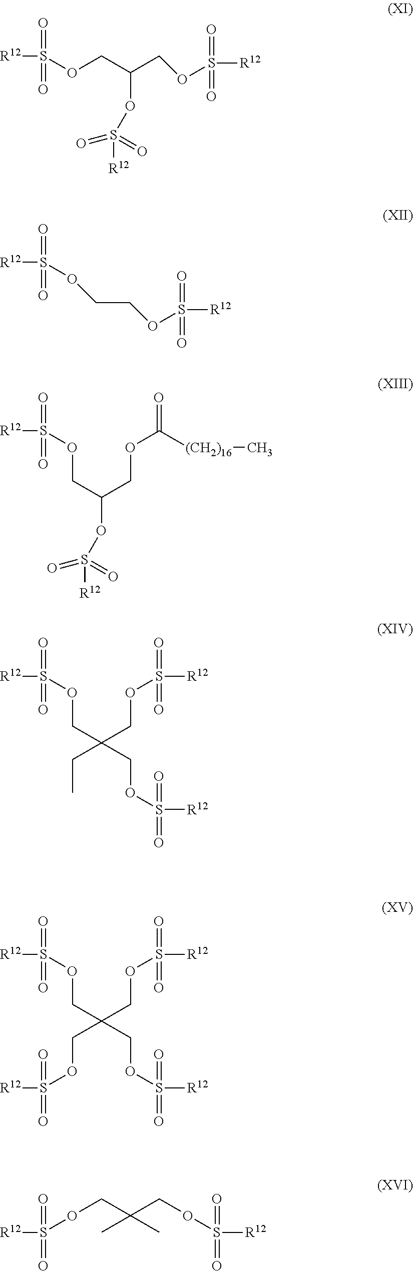

where R¹² in the formulae (XI) to (XVI) is in each case independently C₆- to C₂₀-aryl or C₇- to C₁₂-aralkyl, preferably selected from the list consisting of phenyl, cresyl, xylenyl, propylphenyl, butylphenyl, tert-butylphenyl, more preferably selected from the list consisting of phenyl, cresyl, xylenyl, most preferably phenyl.

Most preferred as component C is the sulfonic ester of formula (XVII)

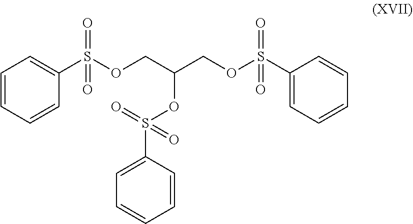 [SMILES: O=S(=O)(OCC(COS(=O)(=O)c1ccccc1)OS(=O)(=O)c1ccccc1)c1ccccc1]

The inventive compounds of component C may be added to the composition individually or in any desired mixtures.

The compounds of component C preferably have melting points greater than 30° C., preferably greater than 40° C. and more preferably greater than 50° C., and boiling points at 1 mbar greater than 150° C., preferably greater than 200° C. and more preferably greater than 230° C.

### Component D

The composition may comprise as component D one or more further additives, preferably selected from the group consisting of flame retardants (e.g. organic phosphorus or halogen compounds, in particular bisphenol A-based oligophosphate), anti-dripping agents (for example compounds from the substance classes of the fluorinated polyolefins, the silicones and aramid fibres), flame retardant synergists (for example nanoscale metal oxides), smoke inhibitors (for example zinc borate), lubricants and demoulding agents (for example pentaerythritol tetrastearate), nucleating agents, antistats and conductivity additives, further stabilizers (e.g. hydrolysis, heat-ageing and transesterification stabilizers, UV stabilizers), Brønsted-acidic compounds, flowability promoters, compatibilizers, impact modifiers without a core-shell structure, antibacterial additives (for example silver or silver salts), scratchproofing additives (for example silicone oils), IR absorbents, optical brighteners, fluorescent additives, further polymeric constituents other than components A and B (for example functional blend partners), dyes and pigments, and fillers and reinforcers (for example carbon fibres, talc, mica, kaolin, CaCO₃).

In a preferred embodiment, the composition is free of flame retardants, anti-dripping agents, flame retardant synergists and smoke inhibitors.

In a likewise preferred embodiment, the composition is free of fillers and reinforcers.

In a particularly preferred embodiment, the composition is free of flame retardants, anti-dripping agents, flame retardant synergists, smoke inhibitors and fillers and reinforcers.

In a preferred embodiment, the composition comprises at least one polymer additive selected from the group consisting of lubricants and demoulding agents, stabilizers, flowability promoters, compatibilizers, and dyes and pigments.

In a further-preferred embodiment, the additives used in component D are selected from the group consisting of lubricants and demoulding agents, stabilizers, flowability promoters, compatibilizers, and dyes and pigments, the compositions being free of further polymer additives.

There follows a list of the following particular embodiments 1 to 31 of the present invention.

1. Composition for production of a thermoplastic moulding compound, wherein the composition comprises or consists of at least the following constituents:
A) 30% to 94% by weight of a polymer or polymer mixture consisting of at least one representative selected from aromatic polycarbonate and aromatic polyestercarbonate and optionally additionally comprising aromatic polyester,
B) 5% to 65% by weight of rubber-based graft polymer B.1, optionally in a mixture with rubber-free vinyl (co)polymer B.2,
C) 0.001% to 1% by weight of at least one ester of a sulfonic acid,
D) 0% to 30% by weight of one or more polymer additives.

2. Composition according to Embodiment 1, wherein component A comprises or is an aromatic polycarbonate.

3. Composition according to either of the preceding embodiments, wherein component C is an ester of an aromatic sulfonic acid.

4. Composition according to any of the preceding embodiments, wherein component C is selected from at least one compound of the abovementioned formulae (XI) to (XVI).

5. Composition according to any of the preceding embodiments, wherein component C is the sulfonic ester of the abovementioned formula (XVII).

6. Composition according to any of the preceding embodiments, comprising

40-80% by weight of component A,
10-50% by weight of component B,
0.002-0.2% by weight of component C and
0.1-10% by weight of component D.

7. Composition according to any of the preceding embodiments, comprising

50-75% by weight of component A,
20-45% by weight of component B,
0.005-0.05% by weight of component C and
0.2-5% by weight of component D.

8. Composition according to any of the preceding embodiments, wherein component B has a lithium content of <1 mg/kg.

9. Composition according to any of the preceding embodiments, wherein component B has a content of alkali metals other than lithium that adds up to >10 mg/kg.

10. Composition according to any of the preceding embodiments, wherein component B has a content of alkali metals other than lithium that adds up to >20 mg/kg.

11. Composition according to any of the preceding embodiments, wherein component B is free of lithium.

12. Composition according to any of the preceding embodiments, comprising as component D at least one additive selected from the group consisting of lubricants and demoulding agents, stabilizers, flowability promoters, compatibilizers, and dyes and pigments.

13. Composition according to any of the preceding embodiments, wherein component A has a proportion of phenolic OH end groups of at least 200 mg/kg.

14. Composition according to any of the preceding embodiments, consisting to an extent of at least 90% by weight of components A, B, C and D.

15. Composition according to any of the preceding embodiments, consisting to an extent of at least 95% by weight of components A, B, C and D.

16. Composition according to any of the preceding embodiments, consisting of components A, B, C and D.

17. Process for producing an impact-modified thermoplastic moulding compound comprising
A) 30% to 94% by weight of a polymer or polymer mixture consisting of at least one representative selected from aromatic polycarbonate and aromatic polyestercarbonate and optionally additionally comprising aromatic polyester,
B) 5% to 65% by weight of a rubber-based graft polymer B.1, optionally in a mixture with rubber-free vinyl (co)polymer B.2,
D) 0% to 30% by weight of one or more polymer additives,
   wherein the components are mixed with one another and melted and interdispersed at a temperature of 200 to 350° C. in a compounding unit,
   characterized in that, in the process, component C added to the composition is an ester of a sulfonic acid in a concentration of 0.001% to 1% by weight and
   components A, B, C and D and any further components of the composition are mixed in a single step or else, alternatively, component C is first premixed in a first step with the entirety or a portion of component A at room temperature or at an elevated temperature.

18. Process according to Embodiment 17, wherein

40-80% by weight of component A,
10-50% by weight of component B,
0.002-0.2% by weight of component C and
0.1-10% by weight of component D
are used.

19. Process according to Embodiment 17, wherein

50-75% by weight of component A,
20-45% by weight of component B,
0.005-0.05% by weight of component C and
0.2-5% by weight of component D
are used.

20. Process according to any of Embodiments 17 to 19, wherein component A is aromatic polycarbonate and/or aromatic polyestercarbonate containing Fries structures of at least one of the abovementioned formulae (IV) to (VII),

wherein component A contains structural units (IV) to (VII) in an amount that adds up to 50 to 10 000 mg/kg, based on the sum total of the proportions by weight of the polycarbonates and polyestercarbonates present in component A.

21. Process according to Embodiment 20, wherein component A contains structural units (IV) to (VII) in an amount that adds up to 100 to 3000 mg/kg, based on the sum total of the proportions by weight of the polycarbonates and polyestercarbonates present in component A.

22. Process according to Embodiment 20, wherein component A contains structural units (IV) to (VII) in an amount that adds up to 200 to 1200 mg/kg, based on the sum total of the proportions by weight of the polycarbonates and polyestercarbonates present in component A.

23. Process according to any of Embodiments 17 to 22, wherein component C is selected from at least one compound of the abovementioned formulae (XI) to (XVI).

24. Process according to any of Embodiments 17 to 23, wherein component C is the compound of formula (XVII).

25. Process according to any of Embodiments 17 to 24, wherein component B contains lithium in a concentration of >1 mg/kg.

26. Process according to any of Embodiments 17 to 24, wherein component B contains lithium in a concentration of >2 mg/kg.

27. Process according to any of Embodiments 17 to 26, wherein component B has a content of alkali metals other than lithium that adds up to <10 mg/kg.

28. Process according to any of Embodiments 17 to 26, wherein component B has a content of alkali metals other than lithium that adds up to <5 mg/kg.

29. Moulding compound obtained or obtainable by a process according to any of Embodiments 17 to 28.

30. Use of a composition according to any of Embodiments 1 to 16 or of a moulding compound according to Embodiment 29 for production of moulded articles.

31. Moulded article obtained or obtainable from a composition according to any of Embodiments 1 to 16 or from a moulding compound according to Embodiment 29.

### Production of the Moulding Compounds and Moulded Articles

The compositions according to the invention can be used to produce thermoplastic moulding compounds.

The thermoplastic moulding compounds according to the invention can be produced, for example, by mixing the respective constituents of the compositions and melt-compounding and melt-extruding them at temperatures of preferably 200° C. to 350° C., preferably at 230° C. to 330° C., more preferably at 250° C. to 310° C., in customary equipment such as internal kneaders, extruders and twin-shaft screw systems, in known fashion. In the context of this application, this process is generally referred to as compounding. The term moulding compound is thus understood to mean the product obtained when the constituents of the composition are melt-compounded and melt-extruded.

The mixing at room temperature or elevated temperature and/or the melt-compounding of components A to D and any further components of the composition can independently be effected in a known manner in a single step or else in multiple component steps. This means, for example, that some of the constituents can be metered in via the main intake of an extruder and the remaining constituents can be fed in later in the compounding process via a side extruder.

In a particular embodiment, component C is first premixed in a first step with the entirety or a portion of component A at room temperature and optionally and preferably melt-compounded at an elevated temperature of preferably 200 to 350° C. and only thereafter are the further components of the compositions added in a second step, and finally the moulding compound according to the invention is compounded.

The invention also provides a process for producing the moulding compounds according to the invention.

The moulding compounds according to the invention can be used to produce moulded articles of any kind. These may be produced by injection moulding, extrusion and blow-moulding processes for example. A further form of processing is the production of mouldings by thermoforming from previously produced sheets or films.

The constituents of the compositions may also be metered directly into an injection moulding machine or into an extrusion unit and processed to mouldings.

Examples of such mouldings that can be produced from the compositions and moulding compounds according to the invention are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and moulding compounds according to the invention are also suitable for production of the following mouldings or moulded articles: internal fitout parts for rail vehicles, ships, aircraft, buses and other motor vehicles, interior components and bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

### EXAMPLES

### Component A1:

Linear polycarbonate based on bisphenol A, prepared by the melt polymerization method, with a weight-average molecular weight M_{w} of 28 000 g/mol (determined by GPC in methylene chloride against a BPA-PC standard). Component A1 contains a total of 691 mg/kg of structural units of the formulae IV to VII, of which 363 mg/kg are structural units of the formula IV, 56 mg/kg structural units of the formula V, 17 mg/kg structural units of the formula VI and 255 mg/kg structural units of formula VII. Component A has a phenolic OH end group content of 480 mg/kg.

### Component A2:

Linear polycarbonate based on bisphenol A, prepared by the interfacial polymerization method, with a weight-average molecular weight MW of 28 000 g/mol (determined by GPC in methylene chloride against a BPA-PC standard). Component A1 does not contain any structural units of one of the formulae IV to VII and contains a phenolic OH end group content of 150 mg/kg.

### Component B1:

Acrylonitrile-butadiene-styrene (ABS) polymer, prepared by the bulk polymerization process, which contains a disperse phase of polybutadiene-containing rubber particles with inclusions of styrene-acrylonitrile copolymer and a styrene-acrylonitrile-copolymer matrix and has an A:B:S ratio of 23:10:67% by weight and a gel content determined as the fraction insoluble in acetone of 20% by weight. The free, i.e. acetone-soluble, styrene-acrylonitrile copolymer in component B1 has a weight-average molecular weight M_{W} (measured by GPC in tetrahydrofuran as solvent with polystyrene as standard) of 165 kg/mol. The median rubber particle size D50, measured by ultracentrifugation, is 0.85 μm. The melt volume flow rate (MVR) of component B1, measured to ISO 1133 (2012 version) at 220° C. with a die load of 10 kg, is 6.7 ml/10 min. Component B1 contains 3 mg/kg Li and a sum total of less than 1 mg/kg of further alkali metals (in each case determined by means of ICP-OES).

### Component B2:

Preliminary compound composed of 50% by weight of an ABS graft polymer with core-shell structure, prepared by emulsion polymerization of 50% by weight, based on the ABS graft polymer, of a mixture of 23% by weight of acrylonitrile and 77% by weight of styrene in the presence of 50% by weight, based on the ABS graft polymer, of a particulate crosslinked polybutadiene rubber (median particle diameter d₅₀=0.25 μm) and 50% by weight of a copolymer of 77% by weight of styrene and 23% by weight of acrylonitrile with a weight-average molecular weight Mw of 130 000 g/mol (determined by GPC in tetrahydrofuran as solvent and with polystyrene as standard). The following alkali metal contents were ascertained in B2 by means of ICP-OES: Li<1 mg/kg, Na: 10 mg/kg, K: 25 mg/kg, where the FIGURE <1 mg/kg means that the element lithium was undetectable with a detection limit in the analytical method of 1 mg/kg.

### Component C1:

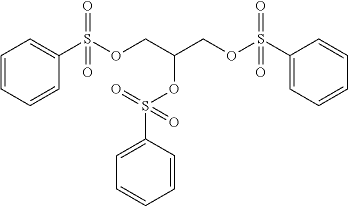 [SMILES: O=S(=O)(OCC(COS(=O)(=O)c1ccccc1)OS(=O)(=O)c1ccccc1)c1ccccc1]

### Synthesis of Component C1 Used:

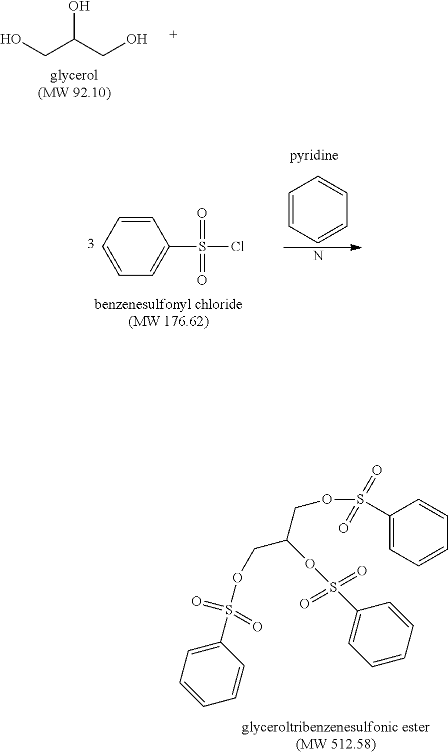

552.6 g (6.0 mol) of glycerol from KMF and 4746 g (60 mol) of pyridine from Aldrich are initially charged under nitrogen and homogeneously dissolved. 3196.8 g (18.1 mol) of benzenesulfonyl chloride are added dropwise very gradually, in the course of which a temperature of 30 to 35° C. should not be exceeded. This is followed by stirring at 40° C. for 1 hour.

Workup:

The mixture is discharged very gradually into a mixture of 3 litres of distilled water, about 4 kg of ice and 3 litres of dichloromethane with vigorous stirring. In the course of this, a temperature of 35° C. should not be exceeded.

The organic phase is then precipitated in about 10 litres of methanol, filtered with suction, and washed with methanol until detection by thin-layer chromatography indicates a clean product.

Subsequently, the product is dried to constant mass in a vacuum drying cabinet at 60° C.

Yield: 970 g (31.54% of theory) of white powder

Analysis:
melting point m.p. 81-83° C.
¹H NMR (400 MHz, TMS, CDCl₃) δ=7.8 ppm (m, 6H), 7.7 (m, 3H), 7.55 (m, 6H), 4.75 (m, 1H), 4.1 (d, 4H).

### Component C2:

phosphorous acid H₃PO₃ (>99%), (Sigma-Aldrich GmbH, Darmstadt, Germany)

Component D1:

pentaerythritol tetrastearate, Loxiol™ P 861/3.5 Special (Emery Oleochemicals GmbH, Dusseldorf, Germany).

### Component D2:

Irganox™ B900 (mixture of 80% Irgafos™ 168 (tris(2,4-di-tert-butylphenyl) phosphite) and 20% Irganox™ 1076 (2,6-di-tert-butyl-4-(octadecanoxycarbonylethyl)phenol); BASF (Ludwigshafen, Germany).

### Production and Testing of the Moulding Compounds According to the Invention

The components were mixed in a Coperion, Werner & Pfleiderer ZSK-25 twin-screw extruder at a melt temperature of 260° C. and with application of a reduced pressure of 50 mbar (absolute). The moulded articles of dimensions 60 mm×40 mm×2 mm were produced at melt temperature 270° C. or 300° C. and a mould temperature of 80° C. on an Arburg 270 E injection moulding machine.

The indicator ascertained for processing stability was the percentage rise in the content of free bisphenol A Δ[BPA] in the production of the moulded articles by injection moulding. For this purpose, the contents of free bisphenol A in the compounded pelletized material [BPA]ₚₑₗₗₑₜₛ and in the injection mouldings [BPA]_{injection moulding} were ascertained and the rise was calculated therefrom by the formula:

Δ[BPA]=100-([BPA]_{injection moulding}−[BPA]ₚₑₗₗₑₜₛ)/[BPA]ₚₑₗₗₑₜₛ

To determine the content of free bisphenol A, the samples were dissolved in dichloromethane and reprecipitated with methanol. The precipitated polymer content was filtered off and the filtration solution was concentrated. The content of free BPA in the concentrated filtrate solution was determined by HPLC with UV detection with an external standard.

A measure used for the hydrolysis stability of the compositions is the relative change in MVR measured to ISO 1133 (2012 version) at 260° C. with a die load of 5 kg and with a hold time of 5 min in the course of storage of the pelletized material under hot and humid conditions (“HH storage”) at 95° C. and 100% relative humidity for 7 days. The relative increase in MVR relative to the MVR before the storage in question is calculated as ΔMVR(hydr) which is defined by the formula below:

$$Δ M V R ( h y r d r ) = \frac{MVR ( after HH storage - MVR ( before storage )}{MVR ( before storage )} \cdot 100 \%$$

TABLE 1
Compositions and properties thereof

| Components | | | |
|---|---|---|---|
| [parts by weight] | V1 | 2 | V3 |
| A1 | 60 | 60 | 60 |
| B1 | 40 | 40 | 40 |
| C1 | | 0.02 | |
| C2 | | | 0.02 |
| D1 | 0.75 | 0.75 | 0.75 |
| D2 | 0.10 | 0.10 | 0.10 |
| Properties | | | |
| Δ BPA [%], injection moulding | 933 | 400 | 550 |
| at 300° C. | | | |
| Δ MVR (hydrolysis) [%] | 5 | 11 | 363 |

The data in Table 1 show that compositions comprising graft polymer prepared by the bulk polymerization method and containing lithium and inventive component C1 achieve an advantageous combination of improved thermal stability (ascertained as the rise in the content of free bisphenol A in the injection moulding process) and high hydrolysis stability. Without component C, hydrolysis stability is good, but thermal stability is entirely unsatisfactory. Noninventive component C2 does improve thermal stability, but not to the level achieved with inventive component C1, and at the cost of a distinct deterioration in hydrolysis stability.

Table 2 compiles experimental data where compositions comprising graft polymer produced by the emulsion polymerization method were examined.

TABLE 2
Compositions and properties thereof

| Components | | | |
|---|---|---|---|
| [parts by weight] | V4 | 5 | V6 |
| A1 | 60 | 60 | 60 |
| B2 | 40 | 40 | 40 |
| C1 | | 0.02 | |
| C2 | | | 0.02 |
| D1 | 0.75 | 0.75 | 0.75 |
| D2 | 0.10 | 0.10 | 0.10 |
| Properties | | | |
| Δ BPA [%], injection moulding | 271 | 188 | 680 |
| at 300° C. | | | |
| Δ MVR (hydrolysis) [%] | 26 | 24 | 116 |

Analogously to the results from Table 1, the data from Table 2 show that the addition of inventive component C1 results in the best combination of thermal stability and hydrolysis stability.

The compositions containing graft polymer prepared by the emulsion polymerization method, by comparison with the compositions containing graft polymer prepared by the bulk polymerization method, feature a lower A BPA, but a higher A MVR (hydrolysis). In both cases, however, inventive component C1 achieves advantageous characteristics compared to noninventive component C2 or compared to compositions without a component C.

TABLE 3
Compositions and properties thereof

| Components | | | | |
|---|---|---|---|---|
| [parts by weight] | V6 | 7 | V8 | 9 |
| A1 | 60 | 60 | | |
| A2 | 60 | 60 | | |
| B1 | 40 | 40 | 40 | 40 |
| C1 | | 0.01 | | 0.01 |
| D1 | 0.75 | 0.75 | 0.75 | 0.75 |
| D2 | 0.10 | 0.10 | 0.10 | 0.10 |
| Properties | | | | |
| Δ BPA [%], injection moulding | 204 | 191 | 207 | 93 |
| at 270° C. | | | | |

The data in Table 3 show that the addition of inventive component C1 has a particularly positive effect on processing stability when, in conjunction with a graft polymer containing lithium as component A, an aromatic polycarbonate containing Fries structures of the formulae (IV) to (VII) is used. In such a case (Example 9), the rise in free bisphenol A in the injection moulding, as a result of the addition of component C1, is reduced considerably more distinctly than in Example 7, in the composition of which component A does not contain any Fries structures of the formulae (IV) to (VII).

1. A thermoplastic moulding composition, wherein the composition comprises:
A) 30% to 94% by weight of a polymer or polymer mixture comprising an aromatic polycarbonate or an aromatic polyestercarbonate and optionally further comprising an aromatic polyester,
B) 5% to 65% by weight of rubber-based graft polymer B.1, optionally in a mixture with rubber-free vinyl (co)polymer B.2,
C) 0.001% to 1% by weight of at least one ester of a sulfonic acid,
D) 0% to 30% by weight of one or more polymer additives.

2. The composition of claim 1, wherein component A is an aromatic polycarbonate.

3. The composition of claim 1, wherein component C is selected from at least one compound of the formulae (XI) to (XVI) 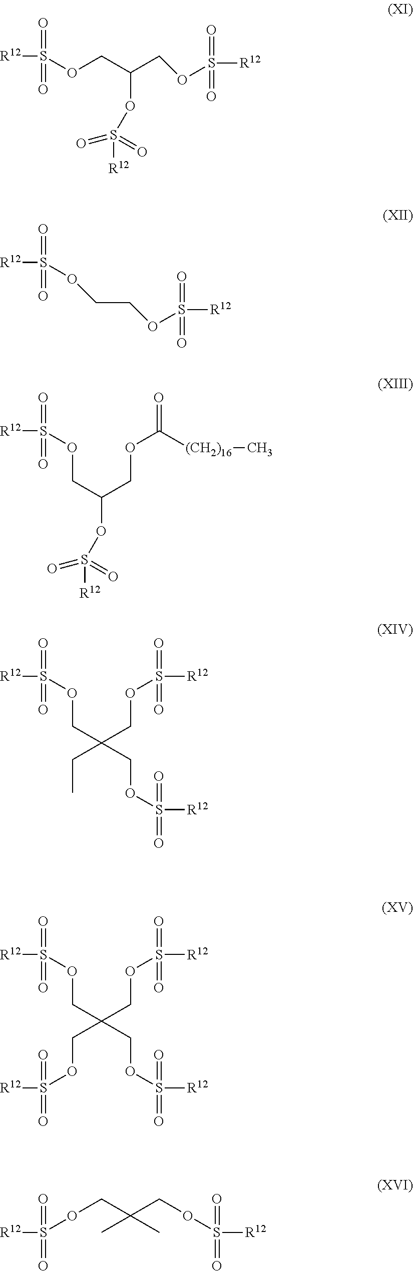
where R¹² in the formulae (XI) to (XVI) is in each case independently C₆- to C₂₀-aryl or C₇- to C₁₂-aralkyl.

4. The composition of claim 1, wherein component C is the sulfonic ester of formula (XVII)

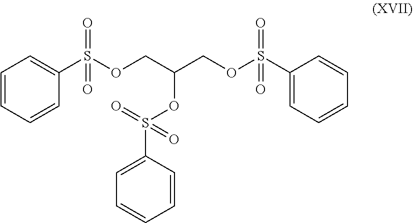 [SMILES: O=S(=O)(OCC(COS(=O)(=O)c1ccccc1)OS(=O)(=O)c1ccccc1)c1ccccc1]

5. The composition of claim 1 comprising:
50-75% by weight of component A,
20-45% by weight of component B,
0.005-0.05% by weight of component C and
0.2-5% by weight of component D.

6. The composition of claim 1, wherein component B has a lithium content of <1 mg/kg.

7. The composition of claim 1, wherein component D comprises at least one additive selected from the group consisting of lubricants and demoulding agents, stabilizers, flowability promoters, compatibilizers, and dyes and pigments.

8. The composition according to of claim 1, wherein component A has a proportion of phenolic OH end groups of at least 200 mg/kg.

9. A process for producing an impact-modified thermoplastic moulding compound comprising:
A) 30% to 94% by weight of a polymer or polymer mixture consisting of at least one of an aromatic polycarbonate and aromatic polyestercarbonate and optionally further comprising an aromatic polyester,
B) 5% to 65% by weight of a rubber-based graft polymer B.1, optionally in a mixture with rubber-free vinyl (co)polymer B.2, and
D) 0% to 30% by weight of one or more polymer additives,
wherein the components are mixed with one another and melted and interdispersed at a temperature of 200 to 350° C. in a compounding unit,
wherein component C is added to the composition, an ester of a sulfonic acid in a concentration of 0.001% to 1% by weight, and
wherein components A, B, C and D and any further components of the composition are mixed in a single step, or alternatively, component C is first premixed in a first step with the entirety or a portion of component A at room temperature or at an elevated temperature.

10. The process of claim 9, wherein component A is aromatic polycarbonate and/or aromatic polyestercarbonate containing Fries structures of at least one of the formulae (IV) to (VII) 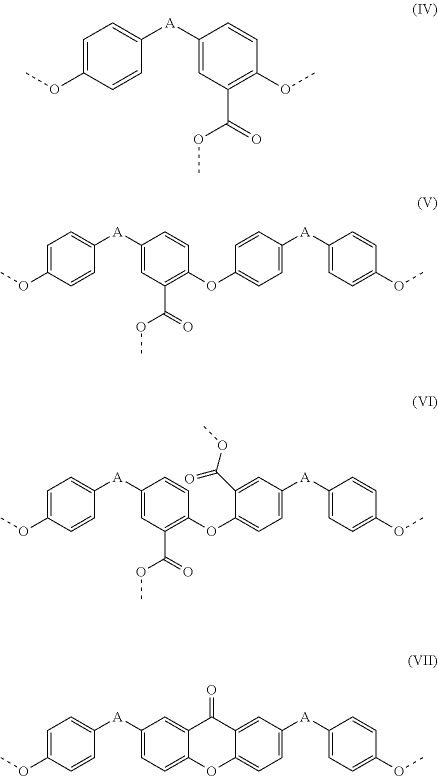
in which the phenyl rings may each independently be mono- or di-substituted by C1-C8-alkyl, or halogen, and
where A is
a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused,
or a radical of formula (II) or (III) 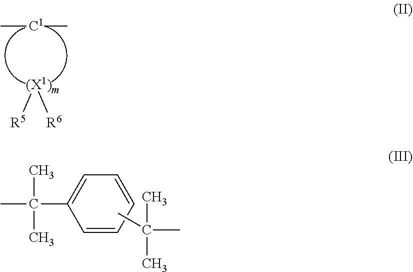
wherein
R⁵ and R⁶ can be chosen individually for each X¹ and are independently hydrogen or C₁ to C₆-alkyl,
X¹ is carbon and
m represents an integer from 4 to 7,
with the proviso that, on at least one X¹ atom, R⁵ and R⁶ are both alkyl, and
wherein component A contains structural units (IV) to (VII) in an amount that adds up to 50 to 10 000 mg/kg, based on the sum total of the proportions by weight of the polycarbonates and polyestercarbonates present in component A.

11. The process of claim 9, wherein component C is selected from at least one compound of the formulae (XI) to (XVI) 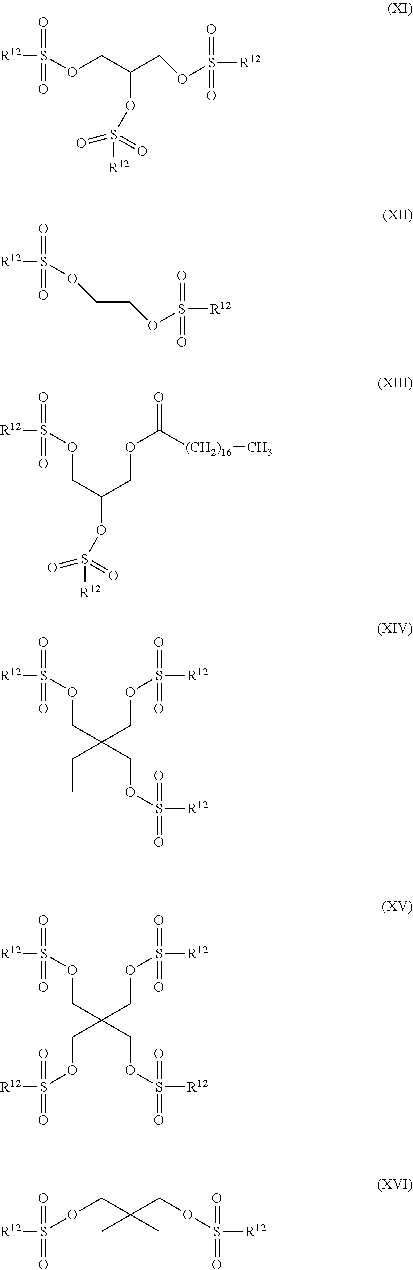
where R¹² in the formulae (XI) to (XVI) is in each case independently C₆- to C₂₀-aryl or C₇- to C₁₂-aralkyl.

12. The process of claim 9, wherein component B contains lithium in a concentration of >1 mg/kg.

13-15. (canceled)
